(19) United States
(12) Patent Application Publication
(10) Pub. No.: US 2004/0150511 A1
(43) Pub. Date: Aug. 5, 2004

(54) Medical alert system for vehicles to reduce potential of death

(76) Inventors: Emily Erin Wilkinson, Carbondale, IL (US); Carol Arlene Wilkinson, Harrisburg, IL (US)

Correspondence Address: Emily Erin Wilkinson, P.O. Box 547, Harrisburg, IL, 62946, US

(21) Appl. No.: 10/285,324

(22) Filed: Jan. 31, 2003

(51) Int. Cl. B60Q 1/00

(52) U.S. Cl. 340/425.5; 340/573.1

(57) ABSTRACT

The medical alert system in a vehicle recognizes human life in a death threatening environment within a vehicle and clearly screams through an exterior speaker system, in Spanish and English, “This is a Medical Emergency, call 911”. To reduce potential death of a child, elderly, or animal within interior location of vehicles said system is comprised of components collectively reacting to environment within any area of the interior of vehicles and their trunks when applicable. Sensor detection recognizes life anyplace within vehicle perimeters. This relays criteria adaptable to specific thresholds. Elements interact with relays to vehicle battery and loud public speaker system. Specific thresholds create the reaction. The system may only be deactivated if the door and trunk are opened. Ignition position is insignificant. If air conditioning defaults, the collective censoring relays trigger the scream for help.

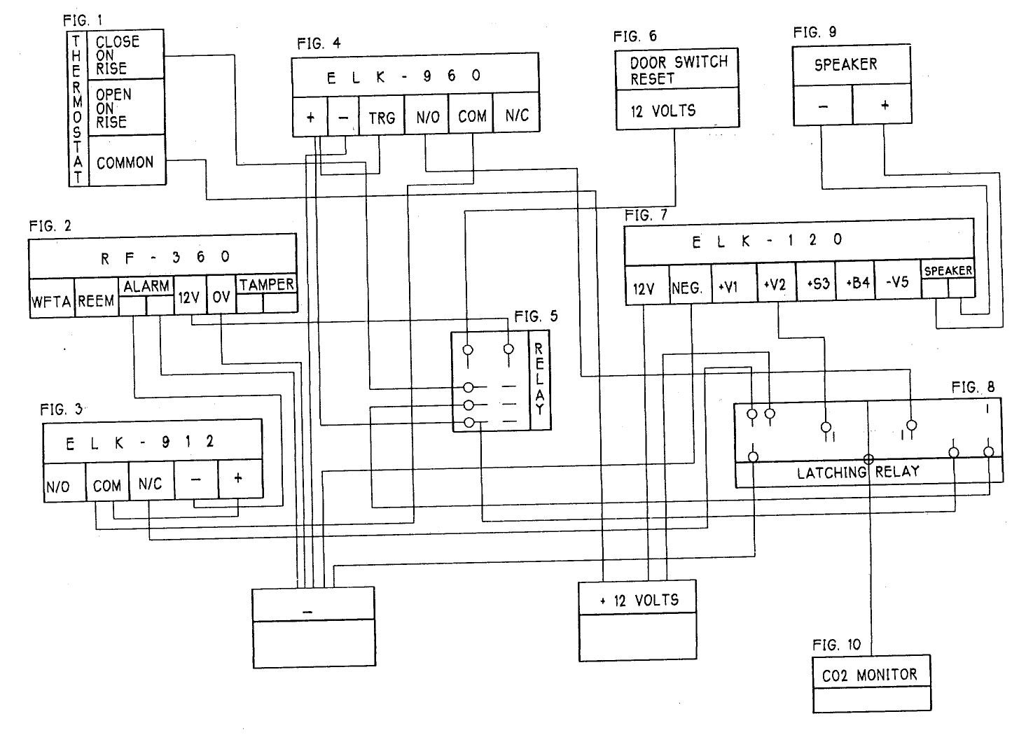

### FIELD OF THE INVENTION

This medical alert vehicle system reduced potential death of living beings within life threatening vehicle environments.

### BACKGROUND OF THE INVENTION

Children, elderly and animals retained within the interior of a vehicle or closed in a vehicle trunk may be exposed to environmental temperatures resulting in death. To decrease the potential of death, the system heretofore recognizes and increases probability for outside intervention with a scream for public intervention.

One device for safety establishes a relay to the vehicle horn. When established criteria are met for extreme interior vehicle temperatures, the vehicle horn sounds. On any given day in large parking areas, a vehicle horn can be heard waling consistently. Onlookers have become familiar with motorists who inadvertently press the Panic Button on the remote door opener. Thereby most bystanders don't turn their heads or go to the vehicle to offer help. The medical alert system substantially increases the means for potential outside intervention with the speaker screaming Medical Emergency Please Call 911 in English and Spanish. This addresses the likelihood of outside intervention since our nation is one with many Spanish and English speaking individuals. Car seats for children have been equipped with alarm systems. These alarms do not eliminate children from being left. Car seats do not encompass other humans such as the elderly. They do not aid in the safety of animals. The best system would reduce potential death for all humans or animals when retained in a vehicle in unsafe environmental conditions whereby eliminating the question of what the noise means, therefore encouraging intervention from passersby.

### SUMMARY OF THE INVENTION

This objective may be obtained beneficially for the interior of a vehicle with a motion sensor that activates a preset thermostat to establish the zone of danger. The trunk of a vehicle contains an oxygen monitor with a relay back to the respective elements. The motion sensor or oxygen monitor individually interacts with a loud speaker and voice box through a relay switch. The twelve-volt vehicle battery activates the speaker. This interaction takes place whether the ignition is determined to be on or off. The transmission position does not interfere with the medical safety alarm reaction. The vehicle medical safety alarm system scream is deactivated only when the vehicle door is opened or the trunk is opened. Said vehicle medical safety alarm is believed to be an economical system coupled with a simple design. When engaged, said system is believed to be an effective aid for elderly people, children, and animals that face crisis from detainment in vehicles while exposed to specific at risk temperatures.

This system is designed to save potential death of children, elderly or animals left unattended in vehicles. With the increasing economic downfall, parents often area overloaded with activities. Children can be forgotten. With the increasing number of elderly, day care sitters are often in charge of running errands for the elderly. Many times, the elderly ride along, but are too feeble to accompany a day care sitter into a store. Many day care sitters work for minimum wage, have little or no knowledge of the danger within a vehicle if the temperature outside appears comfortable. Time meant for errands can extend in stores from two minutes to many minutes. With temperature at 80 degrees, a vehicle interior will reach 120 degrees with ten minutes. A human being 's organs begin to shut down after less than ten minutes. Nationwide children are left at night outside Casinos while sleeping. An over exuberant gambler can easily allow the nighttime gambling to extend into the following day. Outside in the vehicle, the children have been contained in a vehicle and long before noon, their bodies are baked, whether they are in the floor, car seat, or lying up in the back glass. This system will announce to the public to call for help. The honking horn is no longer viewed as an alert. Passersby instinctively hear a horn and either acknowledge it to be some fool who pushed the panic button while loading packages into a car. Airports and mall parking areas witness numerous “horn blows” daily. The system I have developed is a scream for help, without leaving room for questioning about the issue at hand. It is indeed a medical emergency. The combination of English and Spanish scream addresses the population within the United States and further insures the potential of intervention before death.

I claim:

1. Medical alert system for vehicles for public intervention to reduce potential of death, comprising:
(a) a motion sensor detecting any living form of life within vehicle floor, seating, ceiling and side to side circumference
(b) a thermostat adaptable to specific thresholds for extreme cold or heat
(c) an oxygen sensor for vehicles containing a trunk compartment
(d) A vehicle exterior speaker that screams in English and Spanish “This is a Medical Emergency Call 911”
